(19) United States
(12) Patent Application Publication
(10) Pub. No.: US 2004/0088959 A1
(43) Pub. Date: May 13, 2004

(54) Exhaust gas cleaning system having particulate filter

(75) Inventors: Makoto Saito, Okazaki-city (JP); Shigeto Yahata, Obu-city (JP); Masumi Kinugawa, Okazaki-city (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Aichi-pref (JP)

(21) Appl. No.: 10/697,696

(22) Filed: Oct. 31, 2003

(30) Foreign Application Priority Data
Oct. 31, 2002 (JP) 2002-317862
Jul. 15, 2003 (JP) 2003-274624
Aug. 6, 2003 (JP) 2003-287310

(51) Int. Cl. B01D 46/00

(52) U.S. Cl. 55/523

(57) ABSTRACT

A diesel particulate filter (DPF) fixedly held by a holding member in a metallic case is disposed in an exhaust pipe of a diesel engine. The DPF is a monolithic structural body having a multiplicity of cells provided by porous cell walls. The DPF has wall flow structure in which the cells are blocked alternately with filler on an exhaust gas inlet side or an exhaust gas outlet side of the DPF. The cells in a peripheral area extending inward from a peripheral surface of the DPF by a predetermined width are blocked with the filler on both sides of the DPF. Thus, a peripheral heat-retaining layer having the width of 5 to 20 mm is formed to improve temperature increasing performance at a particulate matter collecting area inside the peripheral heat-retaining layer.

### CROSS REFERENCE TO RELATED APPLICATION

This application is based on and incorporates herein by reference Japanese Patent Applications No. 2002-317862 filed on Oct. 31, 2002, No. 2003-274624 filed on Jul. 15, 2003 and No. 2003-287310 filed on Aug. 6, 2003.

### BACKGROUND OF THE INVENTION

1. Field of the Invention

The present invention relates to an exhaust gas cleaning system for an internal combustion engine having a particulate filter.

2. Description of Related Art

Reduction of particulate matters discharged from a diesel engine is greatly required because of increase in concerns for the environment. A diesel particulate filter (DPF) is known as one of measures to reduce the particulate matters discharged from the engine. A proposed system collects the particulate matters at the DPF or the DPF applied with a catalyst on its surface and regenerates the DPF by combusting and eliminating the collected particulate matters intermittently for the sake of continuous use. The DPF has a multiplicity of cells used as exhaust gas passages. When exhaust gas passes through porous walls providing the cells, the particulate matters are adsorbed and collected by the walls.

A method for controlling the temperature of the exhaust gas flowing into the DPF to a high temperature or a method for increasing the quantity of unburned fuel included the exhaust gas in order to generate heat in catalytic reaction is employed as one of mainstream methods for regenerating the DPF. Thus, the DPF is heated and the particulate matters are combusted. The regeneration of the DPF and the collection of the particulate matters with the DPF are repeated alternately. Therefore, if the particulate matters are combusted unevenly in the regeneration, a collected state of the particulate matters will become uneven. At a portion where a large amount of the particulate matters is collected, rapid self-burning of the particulate matters may occur under some operating conditions, generating the heat. In that case, the DPF may be damaged. Therefore, such uneven combustion of the particulate matters in the regeneration should be prevented.

However, temperature increasing performance at a peripheral portion of the DPF is poor. Therefore, the temperature is lower in the peripheral portion than in the center of the DPF. Accordingly, the particulate matters in the peripheral portion of the DPF are difficult to combust. As a result, the amount of the particulate matters remaining unburned may increase and the particulate matters may accumulate excessively if the regeneration and the collection are repeated. Eventually, the DPF may be damaged by the rapid combustion of the particulate matters.

In a method disclosed in Japanese Patent Unexamined Publication No. H05-133217, sealing members are wound around the periphery of the DPF in the vicinity of an exhaust gas inlet and an exhaust gas outlet of the DPF respectively as a countermeasure for the above problem. Thus, a heat insulation layer of air (an air layer, hereafter) for retaining the heat is formed.

However, in this method, the heat is radiated largely because the heat insulation air layer contacts a case. Therefore, the temperature increasing performance of the DPF cannot be improved effectively. In addition, the method requires a great deal of man-hours for assembly since the sealing members are wound at two positions.

### SUMMARY OF THE INVENTION

It is therefore an object of the present invention to provide a diesel particulate filter (DPF) having a heat-retaining layer with a heat-retaining effect in a peripheral portion of the DPF. Thus, temperature increasing performance is improved and temperature of a filter portion of the DPF is increased evenly during regeneration of the DPF. Thus, an amount of particulate matters remaining unburned can be reduced and the regeneration of the DPF can be performed surely. It is another object of the present invention to provide a DPF having simple structure, facilitating its production and assembly.

According to an aspect of the present invention, an exhaust gas cleaning system has a particulate filter, which is fixedly held by a holding member in a metallic case disposed in an exhaust pipe of an internal combustion engine. The particulate filter is a monolithic structural body having a multiplicity of cells provided by porous walls in parallel with flow of exhaust gas. The monolithic structural body has a particulate matter collecting area and a peripheral heat-retaining layer. The particulate matter collecting area has wall flow structure formed by blocking the cells alternately with filler on an exhaust gas inlet side or an exhaust gas outlet side of the monolithic structural body. The peripheral heat-retaining layer is formed by blocking the cells in a peripheral area extending inward from a peripheral surface of the monolithic structural body by a predetermined width so that the peripheral heat-retaining layer continuously surrounds a periphery of the particulate matter collecting area. The predetermined width of the peripheral heat-retaining layer ranges from 5 to 20 mm.

In a conventionally-structured DPF having no peripheral heat-retaining layer, temperature at an outermost peripheral portion of the DPF cannot be increased to a sufficiently high temperature, at which combustion of particulate matters is progressed. It is because heat radiates from a peripheral surface of the DPF. On the contrary, in the DPF of the present invention, the ends of the cells in the area extending inward from the peripheral surface by a predetermined width are blocked to form an air layer, through which no or little exhaust gas passes. The air layer functions as the peripheral heat-retaining layer. Thus, the heat radiation from the peripheral surface of the DPF can be inhibited and the temperature at the entire particulate matter collecting area can be increased evenly during regeneration of the DPF.

In order to achieve the above temperature increasing effect, the predetermined width of the peripheral heat-retaining layer needs to be set to 5 mm or more and the air layer needs to be continuously disposed around the particulate matter collecting area. The peripheral heat-retaining layer becomes more effective as the predetermined width increases. However, the effect is saturated when the predetermined width reaches 20 mm. Therefore, the predetermined width of the peripheral heat-retaining layer is set in the above range (5 to 20 mm) in order to improve the temperature increasing performance without decreasing particulate matter collecting efficiency. The temperature at the peripheral portion of the DPF can be increased to the vicinity of 600° C. The particulate matters can be combusted effectively and the quantity of the unburned particulate matters can be reduced. Thus, the regeneration of the DPF can be performed surely.

### BRIEF DESCRIPTION OF THE DRAWINGS

Features and advantages of embodiments will be appreciated, as well as methods of operation and the function of the related parts, from a study of the following detailed description, the appended claims, and the drawings, all of which form a part of this application. In the drawings:

FIG. 1A is a schematic diagram showing an exhaust gas cleaning system according to a first embodiment of the present invention;

FIG. 1B is a perspective view showing a diesel particulate filter (DPF) according the first embodiment;

FIG. 1C is an enlarged fragmentary view showing cell structure of the DPF according to the first embodiment;

FIG. 2A is a view showing structure of an end surface of the DPF formed with a peripheral heat-retaining layer according to the first embodiment;

FIG. 2B is an enlarged fragmentary view showing the peripheral heat-retaining layer according to the first embodiment;

FIG. 3A is a schematic longitudinal sectional diagram showing structure of the DPF according to the first embodiment;

FIG. 3B is a schematic longitudinal sectional diagram showing structure of a DPF according to a second embodiment of the present invention;

FIG. 3C is a schematic longitudinal sectional diagram showing structure of a DPF according to a third embodiment of the present invention;

FIG. 4 is a graph showing a temperature increasing effect of the peripheral heat-retaining layer according to the second embodiment;

FIG. 5A is a perspective partly-sectional view showing a DPF according to the second embodiment;

FIG. 5B is a graph showing a temperature increasing effect with respect to width of the peripheral heat-retaining layer according to the second embodiment;

FIG. 6 is a schematic longitudinal sectional diagram showing structure of a DPF according to a fourth embodiment of the present invention;

FIG. 7 is a schematic longitudinal sectional diagram showing structure of a DPF according to a fifth embodiment of the present invention;

FIG. 8A is a view showing structure of an end surface of a DPF according to a sixth embodiment of the present invention;

FIG. 8B is an enlarged fragmentary view showing a peripheral heat-retaining layer of the DPF according to the sixth embodiment;

FIG. 9A is an enlarged fragmentary view showing structure of an end surface of a DPF according to a seventh embodiment of the present invention;

FIG. 9B is an enlarged fragmentary view showing a peripheral heat-retaining layer of the DPF according to the seventh embodiment;

FIG. 9C is an enlarged fragmentary view showing a particulate matter collecting area of the DPF according to the seventh embodiment;

FIG. 10 is an enlarged fragmentary view showing structure of an end surface of a DPF according to an eighth embodiment of the present invention;

FIG. 11 is an enlarged fragmentary view showing structure of an end surface of a DPF according to a ninth embodiment of the present invention; and

FIG. 12 is an enlarged fragmentary view showing structure of an end surface of a DPF according to a tenth embodiment of the present invention.

### DETAILED DESCRIPTION OF THE REFERRED EMBODIMENTS

### First Embodiment

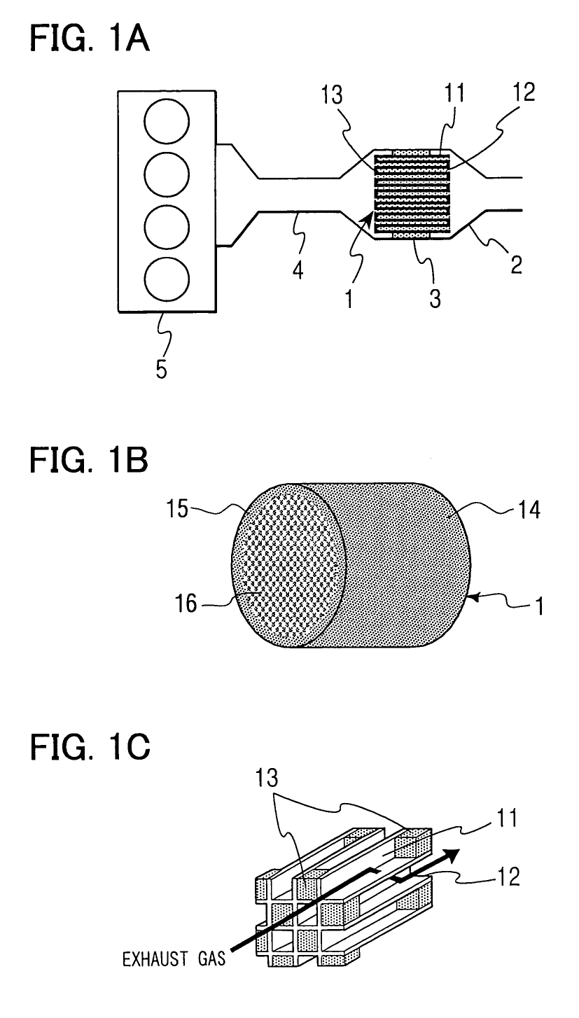

Referring to FIG. 1A, an exhaust gas cleaning system, which is applied to a diesel engine 5, according to the first embodiment of the present invention is illustrated. As shown in FIG. 1A, a metallic case 2 is connected to an exhaust pipe 4 of the engine 5 halfway in the exhaust pipe 4. A diesel particulate filter (DPF) 1 is accommodated in the metallic case 2. A heat-resistant holding member 3 is disposed between the DPF 1 and the metallic case 2. The holding member 3 circumferentially surrounds a peripheral surface of the DPF 1 at the middle of the DPF 1 as shown in FIG. 1A. Thus, the DPF 1 is held and fixed inside the metallic case 2 through the holding member 3.

As shown in FIGS. 1B and 1C, the DPF 1 is formed of a cylindrical monolithic structural body. An inside of the DPF 1 is partitioned by porous cell walls 11 in an axial direction, so a multiplicity of cells 12 parallel to flow of the exhaust gas is formed. An end of each cell 12 of the DPF 1 on an exhaust gas inlet side or an exhaust gas outlet side of the DPF 1 is blocked with filler 13. More specifically, the cells 12 are blocked alternately with the filler 13 so that an opening of a certain cell 12 is blocked if another cell 12 adjacent to the certain cell 12 is not blocked on the exhaust gas inlet side or the exhaust gas outlet side of the DPF 1. Thus, a particulate matter collecting area 16 having wall flow structure is formed as shown in FIG. 1C. In the wall flow structure, the exhaust gas flows between the cells 12 through the cell wall 11. Preferably, a catalyst should be supported on an inner surface of the DPF 1 (surfaces of the cell walls 11). In that case, temperature for combusting the particulate matters can be reduced and the particulate matters can be combusted steadily.

Normally, a cross section of the cell 12 is formed in the shape of a quadrangle. In the first embodiment, the cross section of the cell 12 is formed in the shape of a square. Alternatively, the cross section of the cell 12 may be formed in the shape of a rectangle. Furthermore, the cross section of the cell 12 may be formed in the shape of a triangle, other polygons, or in other shapes. The shape of the periphery of the DPF 1 is not necessarily limited to a round as long as the periphery is formed in a shape similar to the round. As the material of the DPF 1, heat-resistant ceramics such as cordierite can be employed. A porosity and a diameter of the pore of the cell wall 11 and the like can be controlled by regulating a particle diameter of the raw material or quantity of additives, which are eliminated in a baking process. Generally, a pressure loss decreases as the porosity or the pore diameter increases. However, if the porosity or the pore diameter is too large, particulate matter collecting performance is decreased. Therefore, the porosity or the pore diameter may be suitably decided in accordance with required performance. Thickness of the cell wall 11, an area of the opening of each cell 12 and the like are suitably set so that the required particulate matter collecting performance is achieved and the pressure loss is not increased too much.

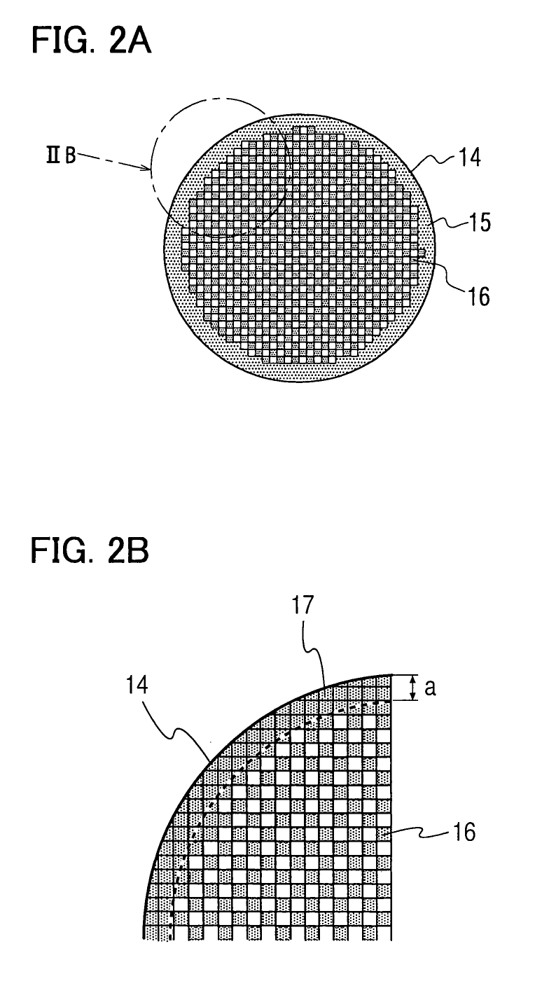

In the first embodiment, the cells 12 near a peripheral surface 14 of the DPF 1 is further blocked with the filler 13 in order to form a peripheral heat-retaining layer 15 at a peripheral portion of the DPF 1. More specifically, as shown in FIGS. 2A and 2B, a peripheral area is assumed to be extending radially inward from a surface of a cylindrical peripheral skin portion 17 (the peripheral surface 14 of the DPF 1) by a predetermined width “a”. FIG. 2B is an enlarged fragmentary view showing a part of an end surface of the DPF 1 shown by an area IIB in FIG. 2A. The peripheral skin portion 17 provides the peripheral wall of the monolithic structural body. All the cells 12 completely or partially included in the peripheral area are blocked with the filler 13 so that the cells 12, whose ends are blocked, continuously surround the periphery of the particulate matter collecting area 16. A broken line in FIG. 2B is a virtual line showing an inner periphery of the peripheral area. The ends of the cells 12 existing on the broken line B are blocked with the filler 13. Therefore, actually, the openings of the cells 12 in an area extending slightly inward from the peripheral area having the width “a” are blocked. A flow rate of the exhaust gas is decreased and the heat radiation to the outside is inhibited at the peripheral heat-retaining layer 15. Therefore, the temperature decrease at the particulate matter collecting area 16 can be inhibited, so the particulate matter collecting area 16 can be maintained above a certain temperature.

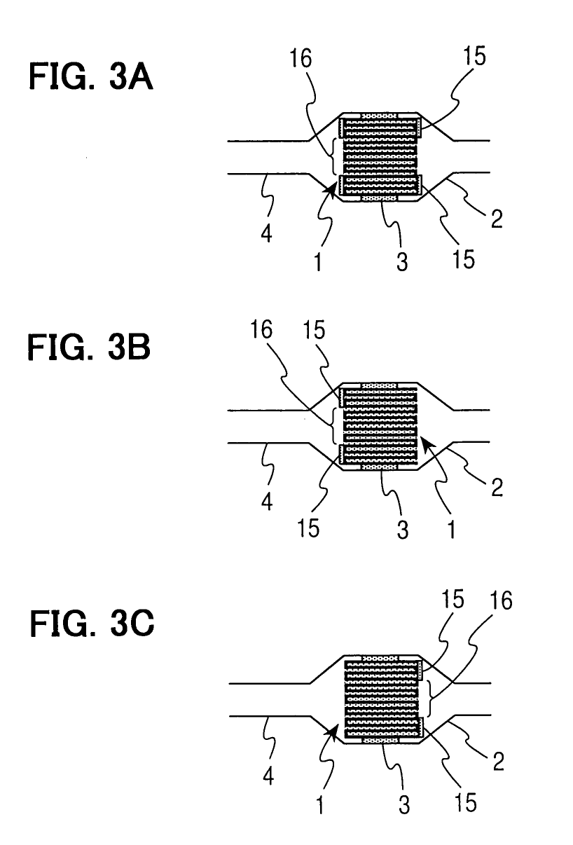

In the first embodiment, all the cells 12 in the peripheral area are blocked with the filler 13 on both the exhaust gas inlet side and the exhaust gas outlet side of the monolithic structural body as shown in FIG. 3A. In the structure, both ends of the cells 12 providing the peripheral heat-retaining layer 15 are blocked, so little or no exhaust gas flows through the peripheral heat-retaining layer 15. Therefore, the heat-retaining performance is improved and the temperature at the particulate matter collecting area 16 can be increased effectively.

### Second Embodiment

Next, a DPF 1 according to the second embodiment of the present invention will be explained based on FIG. 3B. In the second embodiment, all the cells 12 in the peripheral area are blocked with the filler 13 on the exhaust gas inlet side of the DPF 1 as shown in FIG. 3B. Thus, the peripheral heat-retaining layer 15 is formed.

In the DPF 1 of the second embodiment, the ends of the cells 12 providing the heat-retaining layer 15 are partially opened on the exhaust gas outlet side of the DPF 1. Therefore, the exhaust gas can flow through the cells 12 relatively easily compared to the first embodiment. However, a sufficient effect of maintaining the temperature of the particulate matter collecting area 16 above a predetermined value can be achieved by properly setting the predetermined width “a” of the peripheral heat-retaining layer 15. In addition, when the cells 12 are blocked with the filler 13 in the second time, only the inlet side openings of the cells 12 are blocked. Therefore, the production process is simplified compared to the first embodiment.

### Third Embodiment

Next, a DPF 1 according to the third embodiment of the present invention will be explained based on FIG. 3C. In the third embodiment, all the cells 12 in the peripheral area are blocked with the filler 13 on the exhaust gas outlet side of the DPF 1 as shown in FIG. 3C. Thus, the peripheral heat-retaining layer 15 is formed.

In the DPF 1 of the third embodiment, the ends of the cells 12 providing the heat-retaining layer 15 are partially opened on the exhaust gas inlet side of the DPF 1. Therefore, the exhaust gas can flow through the cells 12 relatively easily compared to the first embodiment. However, a sufficient effect of maintaining the temperature of the particulate matter collecting area 16 above a predetermined value can be achieved by properly setting the predetermined width “a” of the peripheral heat-retaining layer 15. In addition, when the cells 12 are blocked with the filler 13 in the second time, only the outlet side openings of the cells 12 are blocked. Therefore, the production process is simplified compared to the first embodiment.

In the first, second and third embodiments, the predetermined width “a” can be set ad libitum so that the required heat-retaining performance is achieved. Preferably, the predetermined width “a” should be set in a range from 5 to 20 mm so that the entire particulate matter collecting area 16 is heated at least to a certain temperature (for instance, 600° C.), at which the combustion of the particulate matters is progressed sufficiently. If the predetermined width “a” is less than 5 mm, the effect of the peripheral portion of the DPF 1 to improve the temperature increasing performance cannot be achieved. In the case where the predetermined width “a” is equal to or greater than 5 mm, the temperature increasing performance is improved as the predetermined width “a” increases. However, if the predetermined width “a” exceeds 20 mm, the effect does not change largely anymore. If the predetermined width “a” exceeds 20 mm, the particulate matter collecting area 16 is narrowed unfavorably.

A normal cell pitch of the DPF 1 generally ranges from 1.32 to 1.62 mm. Therefore, in the DPF 1 formed with an even cell pitch, the predetermined width “a” (5 to 20 mm) corresponds to a value approximately three to fifteen times as large as the normal cell pitch. One cell pitch is defined by a following equation: P=25.4/m/2, where P represents the cell pitch and m is a mesh number. The mesh number m is a number of the cells existing in a square whose side is 25.4 mm long. For instance, if the cell 12 has a square cross section, one cell pitch is the sum of the side length of the cell 12 and the thickness of the cell wall 11. Thickness of the peripheral skin portion 17 is set in a range from 0.2 to 1.0 mm.

The DPF 1 having the above structure according to the first, second or third embodiment is produced in a following method, for instance. First, a normally used additive such as organic foaming material or carbon is mixed into the ceramic material. Then, the mixture is kneaded into a clayey state and is shaped by protrusion. The organic foaming material and the carbon are burned and eliminated in the baking process, forming the pores. After the shaped body is baked temporally, an end of each cell is blocked alternately with the filler 13 in a normal manner. Then, the cells 12 completely or partially included in the peripheral area having the predetermined width “a” are blocked with the filler 13 on an end surface or both end surfaces of the temporally baked body. Then, the baking is performed to complete the DPF 1.

The DPF with a catalyst can be produced by supporting a catalytic element such as catalytic noble metal on the DPF 1 formed in the above process. In this case, catalyst solution is prepared by dissolving compound of the catalytic element in a solvent such as water or alcohol, and the DPF 1 is impregnated with the catalyst solution. Then, the excess catalyst solution is removed and the DPF 1 is dried. Then, the catalytic element is burned into the surface of the DPF 1 in the atmosphere.

Next, operation of the above exhaust gas cleaning system shown in FIG. 1 will be explained. The quantity of the particulate matters collected by the DPF 1 can be calculated by sensing a pressure difference between an upstream side and a downstream side of the DPF 1 with the use of a pressure difference sensor and the like. If it is determined that the calculated quantity of the collected particulate matters reaches a predetermined value, the regeneration of the DPF 1 is performed. The regeneration of the DPF 1 is performed by increasing the temperature of the exhaust gas, which is discharged from the engine 5 to the DPF 1, or by increasing the quantity of unburned fuel included in the exhaust gas so that the heat is generated in catalytic reaction. Thus, the DPF 1 is heated to a sufficiently high temperature, at which the combustion of the particulate matters is progressed. Thus, the particulate matters are combusted and eliminated.

In the conventional structure having no peripheral heat-retaining layer 15, the temperature at the outermost peripheral portion of the DPF 1 is not increased sufficiently, and a part of the particulate matters may remain unburned. In the structure according to the present invention, the peripheral heat-retaining layer 15 inhibits the temperature decrease at the outermost peripheral portion of the DPF 1, so the temperature of the DPF 1 can be held even throughout. Therefore, unevenness in a collected state of the particulate matters caused by the unburned particulate matters can be prevented. Meanwhile, rapid self-burning of the particulate matters can be prevented. The rapid self-burning of the particulate matters is caused under some operating conditions if the particulate matters accumulate excessively in the repetition of the regeneration of the DPF 1 and the collection of the particulate matters. Thus, the regeneration of the DPF 1 can be performed safely and steadily, and durability of the DPF 1 can be improved.

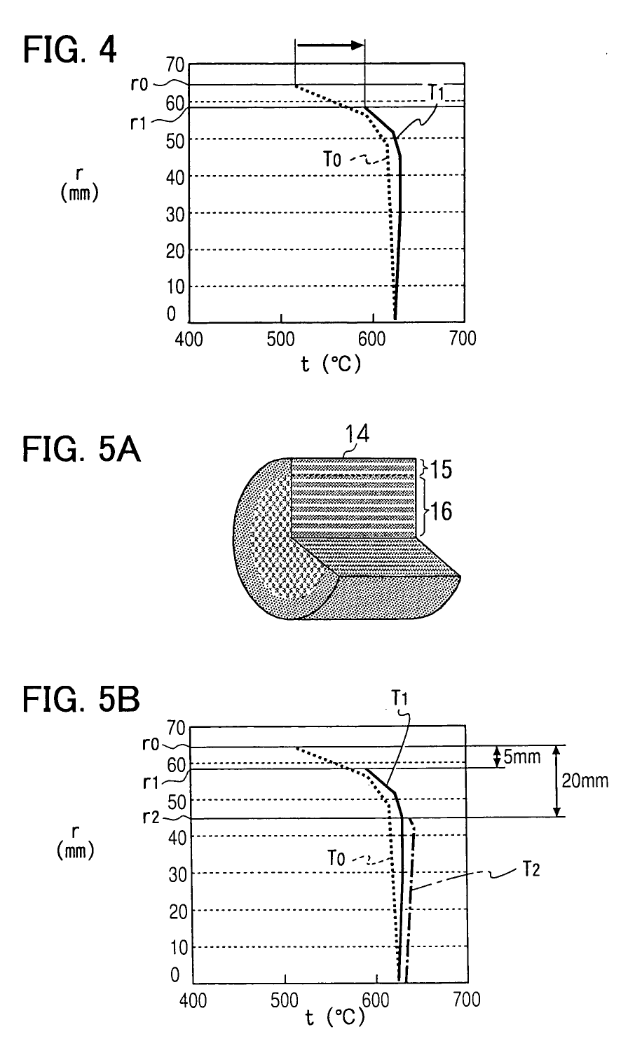

Next, a result of experiment performed to verify the temperature increasing effect of the peripheral heat-retaining layer 15 of the DPF 1 according to the present invention will be explained based on FIG. 4. The DPF 1 according to the second embodiment shown in FIG. 3B is used in the experiment. The cordierite is used as base material of the DPF 1. The predetermined width “a” of the peripheral heat-retaining layer 15 is set to 5 mm. The radius r1 of the particulate matter collecting area 16 is set to 59.5 mm. The length of the DPF 1 in the axial direction is set to 150 mm. The thickness of the cell wall 11 is set to 0.3 mm. The mesh number m is set to 300. The cell 12 is formed in the square shape. The thickness of the peripheral skin portion 17 is set to 0.5 mm. The DPF 1 produced in the above method is fixed in the metallic case 2 and is mounted in the exhaust pipe 4 of the engine 5. In FIG. 4, an axis “r” represents a radial distance from the center of the DPF 1. Thus, the temperature increasing experiment is performed and temperature distribution inside the DPF 1 is measured. The temperature increasing experiment is performed in a typical operation mode (the most frequently appearing mode) in a normal travel.

Meanwhile, a result of similar experiment performed with the conventional DPF having no peripheral heat-retaining layer 15 is shown in FIG. 4. The radius r0 of the particulate matter collecting area 16 of the conventional DPF is set to 64.5 mm. The other configurations of the conventional DPF are the same as the DPF 1 of the present invention.

In FIG. 4, a broken line T0 represents the temperature distribution of the conventional DPF with respect to the distance r and a solid line T1 is the temperature distribution of the DPF 1 of the present invention. As shown by the broken line T0 in FIG. 4, the temperature at the periphery of the conventional DPF is decreased largely (approximately, to 500° C.) compared to its center. Thus, the temperature at the periphery of the DPF cannot be increased to a value for sufficiently progressing the combustion of the particulate matters. On the contrary, as shown by the solid line T1, in the DPF 1 of the present invention, the temperature at the outermost portion of the particulate matter collecting area 16 inside the peripheral heat-retaining layer 15 is increased to the vicinity of 600° C. As a result, the entire DPF 1 can be heated substantially evenly, and the combustion of the particulate matters can be performed efficiently.

Next, the predetermined width “a” of the peripheral heat-retaining layer 15 of the present invention will be examined. The predetermined width “a” of the peripheral heat-retaining layer 15 is set to 20 mm, and the radius r2 of the particulate matter collecting area 16 is set to 44.5 mm as shown in FIG. 5A. The other configurations of the DPF 1 are unchanged. A result of similar experiment performed with the DPF 1 shown in FIG. 5A is shown in FIG. 5B.

In FIG. 5B, a chained line T2 represents the temperature distribution of the DPF 1, in which the predetermined width “a” of the heat-retaining layer 15 is set to 20 mm. As shown by the chained line T2 in FIG. 5B, the temperature increasing effect of the peripheral heat-retaining layer 15 is affected by its width. More specifically, the temperature increasing effect is increased as the width of the peripheral heat-retaining layer 15 increases. As explained above, the outermost portion of the particulate matter collecting area 16 can be heated to the vicinity of 600° C. if the width of the peripheral heat-retaining layer 15 is 5 mm. The particulate matters collected in the DPF 1 can be efficiently combusted at the temperature generally above 600° C. Therefore, the peripheral heat-retaining layer 15 can achieve the temperature increasing effect sufficiently if the width of the peripheral heat-retaining layer 15 is 5 mm or more. The temperature increasing effect is substantially saturated if the width of the peripheral heat-retaining layer 15 reaches 20 mm. Further increase in the width of the peripheral heat-retaining layer 15 has no effect. Moreover, the particulate matter collecting area 16 will be reduced as the width of the peripheral heat-retaining layer 15 is increased.

Thus, the peripheral heat-retaining layer 15 becomes most effective if the predetermined width “a” of the peripheral heat-retaining layer 15 is in the range from 5 to 20 mm. As shown in the result of the experiment with the conventional DPF, the temperature decrease is especially noticeable at the outermost peripheral portion. On the other hand, the temperature near the center of the DPF reaches 600° C., at which the particulate matters can be combusted. It is because the heat inside the DPF 1 radiates from the peripheral portion. Therefore, in order to prevent the heat radiation, the DPF 1 of the present invention is formed with the peripheral heat-retaining layer 15, which has the air layer having the width greater than a predetermined value, at the outermost portion of the DPF 1. Therefore, even in the case where the DPF 1 is formed in a size different from the DPF 1 used in the experiment, a similar effect can be achieved in accordance with the width of the peripheral heat-retaining layer 15. The temperature increasing experiment was performed in the typical operation mode in the normal travel. Therefore, in the normal operating state, the particulate matters can be combusted evenly with the temperature increasing effect of the peripheral heat-retaining layer 15 during the regeneration of the DPF 1. Therefore, the sufficient effect for the practical use can be achieved.

If the thickness of the peripheral skin portion 17 is in the range from 0.2 to 1.0 mm, the thickness of the peripheral skin portion 17 has little effect on the heat-retaining performance of the peripheral heat-retaining layer 15. Therefore, the effects corresponding to the width of the peripheral heat-retaining layer 15 can be achieved. If the thickness of the peripheral skin portion 17 is less than 0.2 mm, strength of the peripheral surface 14 cannot be ensured. If the thickness of the peripheral skin portion 17 exceeds 1.0 mm, the substantial thickness of the peripheral heat-retaining layer 15 is reduced unfavorably. However, in the case where the strength of the DPF 1 needs to be increased, the thickness of the peripheral skin portion 17 may exceed the above range. In this case, preferably, the predetermined width “a” of the peripheral heat-retaining layer 15 should be much larger than the thickness of the peripheral skin portion 17. For instance, if the peripheral portion 17 is formed to be 5 mm thick, the predetermined width “a” should be set to 20 mm in order to ensure the thickness of the air layer required to improve the temperature increasing performance. The thickened peripheral skin portion 17 has an effect of sufficiently increasing the drag of the DPF 1 against extraneous force applied from the outside in the radial direction.

### Fourth Embodiment

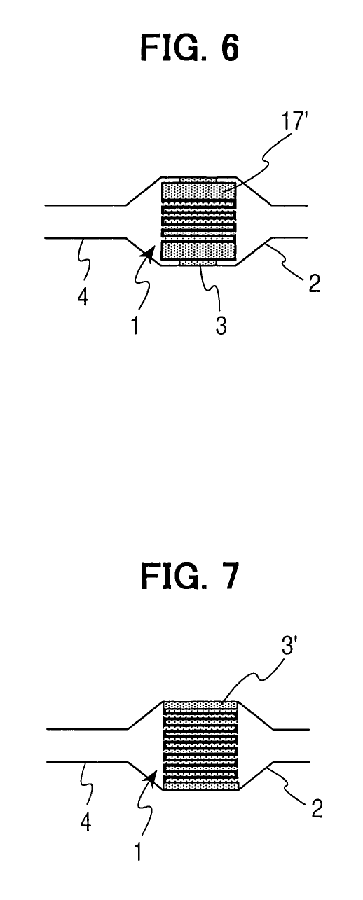

Next, a DPF 1 according to the fourth embodiment will be explained based on FIG. 6. As shown in FIG. 6, a peripheral heat-retaining layer is formed by thickening a peripheral skin portion 17′ compared to the normal DPF. Also in this case, the thickness of the peripheral skin portion 17′ should preferably be set in a range from 5 to 20 mm so that a required temperature increasing effect is achieved. For instance, the peripheral skin portion of the conventional DPF is generally formed to be 0.5 mm thick and exerts little or no heat-retaining effect as shown in FIG. 4. On the other hand, the peripheral skin portion 17′ of the present embodiment is formed to be 5 mm thick or more. Therefore, the temperature increasing performance during the regeneration of the DPF 1 is improved and the effect of combusting the particulate matters efficiently can be achieved. However, if the peripheral skin portion 17′ becomes too thick, the temperature increasing effect is not improved largely. In addition, the particulate matter collecting area becomes narrow. Therefore, the thickness of the peripheral skin portion 17′ should be preferably set to 20 mm or less.

More preferably, inner structure of the thick peripheral skin portion 17′ should be made in the form of ceramic foam. The peripheral skin portion 17′ as the heat-retaining layer is formed so that air content is higher in an interior portion of the peripheral skin portion 17′ than in the surface layer of the peripheral skin portion 17′. Thus, the mixture of the ceramics and the air increases the air content in the peripheral heat-retaining layer. The peripheral heat-retaining layer thus formed has an effect of improving the heat-retaining effect. Meanwhile, the peripheral heat-retaining layer has an effect of improving the drag of the DPF 1 against the force applied from the outside in the radial direction, while reducing the weight of the DPF 1.

Since the peripheral heat-retaining layer can be formed in a protruding process of the DPF 1, there is no need to change the production process. That is, there is no need to block the cells 12 in the area extending from the peripheral surface 14 by the predetermined width (5 to 20 mm) with the filler 13. Thus, the production process is simplified.

### Fifth Embodiment

Next, a DPF 1 according to the fifth embodiment of the present invention will be explained based on FIG. 7. As shown in FIG. 7, a holding member 3′ for holding the periphery of the DPF 1 is formed to be thicker than the normal holding member. The holding member 3′ covers an area of 50 to 100 percent of the peripheral surface of the DPF 1. Thus, the heat-retaining layer is formed. Also in this case, the thickness of the holding member 3, after an assembling process should be preferably set in a range from 5 to 20 mm. The thickness of the holding member 3′ is suitably set in the above range so that a required temperature increasing effect is achieved. If the thickness of the holding member 3′ is less than 5 mm, the temperature increasing performance is not improved. If the thickness of the holding member 3′ exceeds 20 mm, the temperature increasing effect is not improved largely, and the particulate matter collecting area of the DPF 1 is reduced unfavorably. The temperature increasing effect can be achieved if at least 50 percent of the peripheral surface of the DPF 1 is covered by the holding member 3′. The covered area of the peripheral surface of the DPF 1 may be determined as required. In an example shown in FIG. 7, 100 percent of the peripheral surface of the DPF 1 is covered by the holding member 3′.

Preferably, material capable of expanding for holding the DPF 1 fixedly when the material is heated should be used as the holding member 3′. More specifically, a certain material (for instance, material available on the market under the trade name of Interam Mat from Sumitomo 3M Ltd.) that is formed in the shape of a sheet made of multi-layered natural mineral material combined with resin and expands in a direction of its thickness when heated can be used as the holding member 3′. The holding member 3′ is wound around the periphery of the DPF 1 and is disposed in the metallic case 2 in that state. If the engine 5 is operated, the holding member 3′ expands in the direction of its thickness due to the heat of the exhaust gas and fixes the DPF 1 in the metallic case 2. Thus, the DPF 1 can be mounted easily and can be fixed surely. Since the structure of the DPF 1 is not changed, the conventional DPF can be used. Therefore, the peripheral heat-retaining layer can be formed without increasing the production cost largely.

### Sixth Embodiment

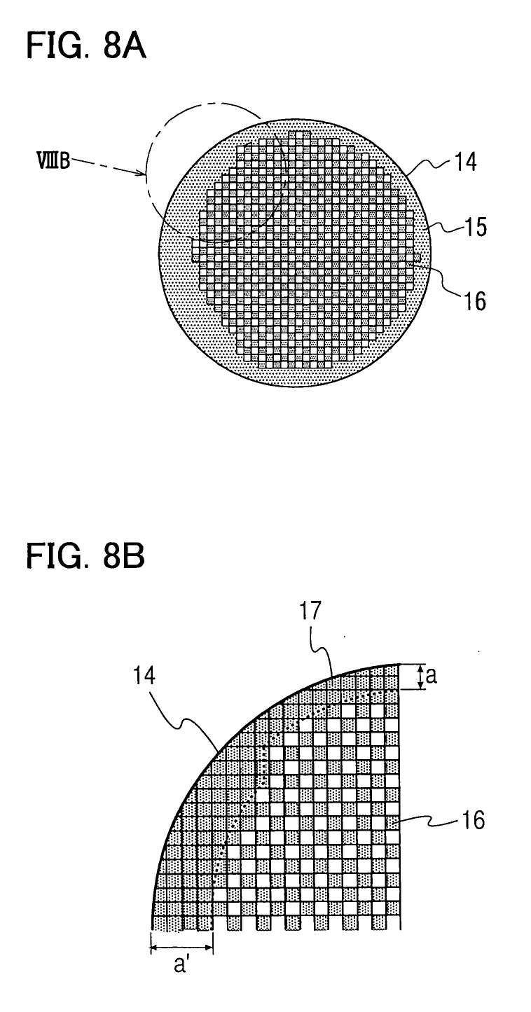

Next, a DPF 1 according to the sixth embodiment of the present invention will be explained based on FIGS. 8A and 8B. In the DPF 1 of the sixth embodiment, the width of the peripheral heat-retaining layer 15 is partially changed. For instance, if characteristics in the temperature increase at the periphery of the DPF 1 are biased because of distribution in flow velocity of the entering exhaust gas, the width of the peripheral heat-retaining layer 15 may be increased partially from the predetermined width “a” to another width “a′” 11 as shown in FIG. 8B. Thus, a part having improved temperature increasing performance can be formed. FIG. 8B is an enlarged fragmentary view showing a part of an end surface of the DPF 1 shown by an area VIIIB in FIG. 8A. On the other hand, at a part having high temperature increasing performance, the width of the peripheral heat-retaining layer 15 may be decreased from the predetermined width “a”. Thus, an effective cross-sectional area of the particulate matter collecting area 16 can be increased and the particulate matter collecting performance can be improved.

Thus, the width of the peripheral heat-retaining layer 15 can be changed between two levels or more in accordance with the temperature increasing characteristics. Thus, high temperature increasing efficiency and high particulate matter collecting efficiency can be achieved more effectively.

### Seventh Embodiment

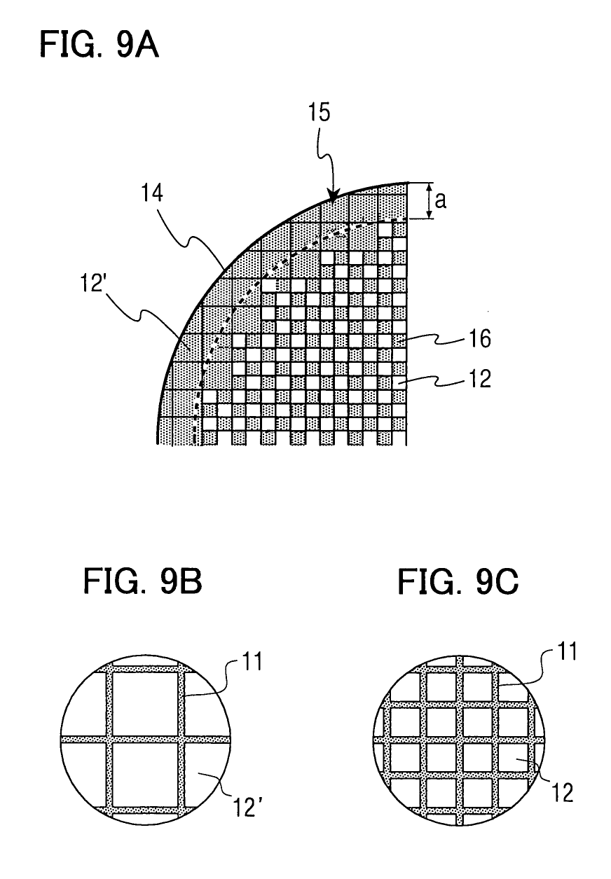

Next, a DPF 1 according to the seventh embodiment of the present invention will be explained based on FIGS. 9A, 9B and 9C. In the DPF 1 of the seventh embodiment, the cell pitch or the shape of the cell is changed so that a ratio of an area occupied by the air layer per unit cross-sectional area of the DPF 1 is greater in the peripheral heat-retaining layer 15 than in the particulate matter collecting area 16. More specifically, as shown in FIG. 9A, the cell pitch of the cell 12′ providing the peripheral heat-retaining layer 15 is formed to be greater than the cell pitch of the cell 12 providing the particulate matter collecting area 16. In FIG. 9A, the cell pitch at the peripheral heat-retaining layer 15 is generally twice as large as the normal cell pitch (1.32 to 1.62 mm) at the particulate matter collecting area 16. The cell 12 is formed in the shape of a square. The cell 12′ is formed in the shape of a square, too.

Thus, a ratio of an area occupied by the cell walls 11 in a certain cross-sectional area at the peripheral heat-retaining layer 15 shown in FIG. 9B becomes smaller than that at the particulate matter collecting area 16 shown in FIG. 9C. Accordingly, a ratio of the cross-sectional area of the air layer surrounded by the cell walls 11 is increased at the peripheral heat-retaining layer 15. As a result, the heat-retaining performance is improved compared to the DPF 1 formed with an identical cell pitch. Thus, the temperature decrease at the periphery of the DPF 1 can be prevented and the DPF 1 can be heated more evenly throughout.

### Eighth Embodiment

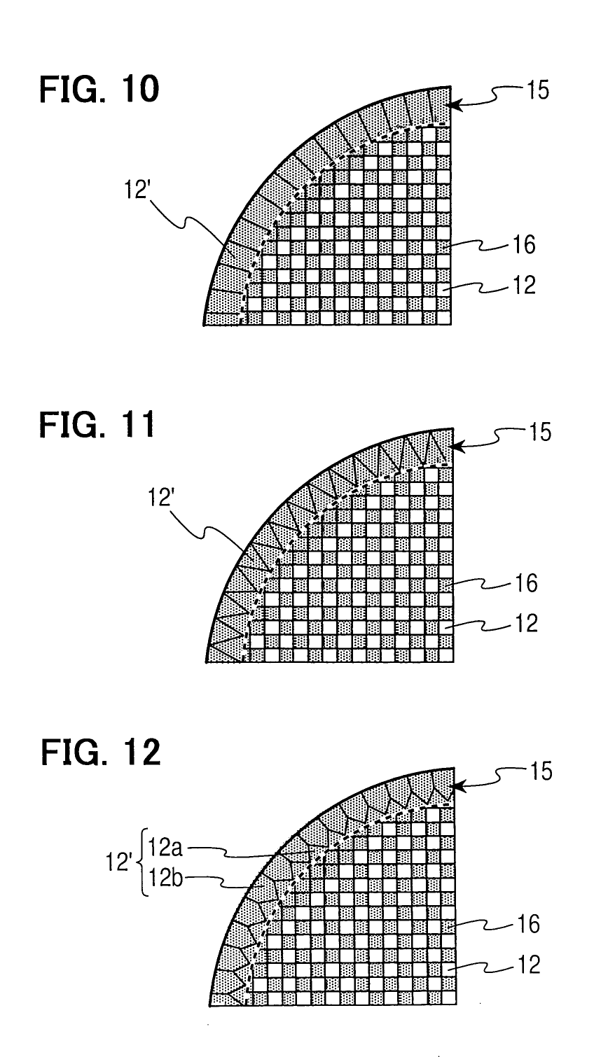

Next, a DPF 1 according to the eighth embodiment of the present invention will be explained based on FIG. 10. In the DPF 1 of the eighth embodiment, the cell 12′ providing the peripheral heat-retaining layer 15 is formed substantially in a rectangular shape, which is different from the shape of the cell 12 providing the particulate matter collecting area 16. The cells 12′ are formed so that the cell walls 11 of the cells 12′ are disposed in the radial directions of the DPF 1 as shown in FIG. 10. The cross-sectional area of the cell 12′ providing the peripheral heat-retaining layer 15 is formed to be greater than that of the cell 12 providing the particulate matter collecting area 16. For instance, the cross-sectional area of the cell 12′ is set so that the ratio of the area occupied by the air layer per unit cross-sectional area of the DPF 1 at the peripheral heat-retaining layer 15 is similar to that of the seventh embodiment.

Since the cell walls 11 are disposed in the radial directions of the DPF 1, the ratio of the volume occupied by the air layer along the direction of the heat radiation is increased. Therefore, the heat-retaining effect is improved more. The cell walls 11 are disposed in the directions for exerting the drag against the pressure, which is applied to the peripheral surface of the DPF 1 when the DPF 1 is mounted. Therefore, the strength of the DPF 1 is improved. In the DPF 1 shown in FIG. 10, a single layer of the cells 12′ is disposed so that the cells 12′ surround the particulate matter collecting area 16. Alternatively, two or more layers of the cells 12′ may be disposed.

### Ninth Embodiment

Next, a DPF 1 according to the ninth embodiment of the present invention will be explained based on FIG. 11. In the DPF 1 of the ninth embodiment, the cross-section of the cell 12′ providing the peripheral heat-retaining layer 15 is formed in the shape of a triangle, which has a larger cross-sectional area than the cell 12 providing the particulate matter collecting area 16. The cell walls 11 of the cells 12′ are disposed in directions for exerting the drag against the pressure applied to the peripheral surface of the DPF 1. Thus, the strength of the DPF 1 can be improved further, while increasing the ratio of the volume occupied by the air layer. Also in this case, one or more layers of the triangle cells 12′ may be disposed.

### Tenth Embodiment

Next, a DPF 1 according to the tenth embodiment of the present invention will be explained based on FIG. 12. In the DPF 1 of the tenth embodiment, the cell 12′ providing the peripheral heat-retaining layer 15 is formed by combining a triangle cell 12a and a pentagonal cell 12b. The triangle cell 12a is disposed radially inside the pentagonal cell 12b. Thus, the heat-retaining effect provided by the air layer is compatible with the strength of the DPF 1.

As explained above, the shape of the cell 12′ providing the peripheral heat-retaining layer 15 can be set arbitrarily to achieve the required heat-retaining effect and the strength. Thus, the highly useful DPF 1 having high particulate matter combusting efficiency and durability is provided.

The present invention should not be limited to the disclosed embodiments, but may be implemented in many other ways without departing from the spirit of the invention.

What is claimed is:

1. An exhaust gas cleaning system for an internal combustion engine, the exhaust gas cleaning system comprising:
a particulate filter, which is fixedly held by a holding member in a metallic case disposed in an exhaust pipe of the engine and collects particulate matters included in exhaust gas, wherein
the particulate filter is formed of a monolithic structural body having a multiplicity of cells provided by porous walls in parallel with flow of the exhaust gas,
the particulate filter has a particulate matter collecting area having wall flow structure, in which the cells are blocked alternately with filler on an exhaust gas inlet side or an exhaust gas outlet side of the particulate filter, and a peripheral heat-retaining layer, which is formed by blocking the cells in a peripheral area extending inward from a peripheral surface of the monolithic structural body by a predetermined width so that the peripheral heat-retaining layer continuously surrounds a periphery of the particulate matter collecting area, and
the predetermined width of the peripheral heat-retaining layer ranges from 5 to 20 millimeters.

2. The exhaust gas cleaning system as in claim 1, wherein
the monolithic structural body has a peripheral skin portion providing a peripheral wall of the monolithic structural body,
the peripheral surface of the monolithic structural body serves as a peripheral surface of the peripheral skin portion, and
the peripheral skin portion has thickness in a range from 0.2 to 1.0 millimeter.

3. The exhaust gas cleaning system as in claim 1, wherein the heat-retaining layer is formed by blocking the entire cells in the peripheral area, which extends inward from the peripheral surface of the monolithic structural body by the predetermined width, on both the exhaust gas inlet side and the exhaust gas outlet side of the monolithic structural body.

4. The exhaust gas cleaning system as in claim 1, wherein the peripheral heat-retaining layer is formed by blocking the entire cells in the peripheral area, which extends inward from the peripheral surface of the monolithic structural body by the predetermined width, on the exhaust gas inlet side of the monolithic structural body.

5. The exhaust gas cleaning system as in claim 1, wherein the peripheral heat-retaining layer is formed by blocking the entire cells in the peripheral area, which extends inward from the peripheral surface of the monolithic structural body by the predetermined width, on the exhaust gas outlet side of the monolithic structural body.

6. The exhaust gas cleaning system as in claim 1, wherein the peripheral heat-retaining layer is formed by blocking the cells, which are completely or partially included in the peripheral area.

7. The exhaust gas cleaning system as in claim 1, wherein the width of the peripheral heat-retaining layer is partially changed in accordance with temperature increasing characteristics at respective peripheral portions of the monolithic structural body.

8. The exhaust gas cleaning system as in claim 1, wherein the monolithic structural body is formed so that a ratio of an area occupied by a layer of air per unit cross-sectional area of the monolithic structural body is higher in the peripheral heat-retaining layer than in the particulate matter collecting area.

9. The exhaust gas cleaning system as in claim 8, wherein the monolithic structural body is formed so that a cell pitch of the cell is greater in the peripheral heat-retaining layer than in the particulate matter collecting area.

10. The exhaust gas cleaning system as in claim 8, wherein the cell in the peripheral heat-retaining layer is formed in a shape different from the shape of the cell in the particulate matter collecting area.

11. An exhaust gas cleaning system for an internal combustion engine, the exhaust gas cleaning system comprising:
a particulate filter, which is fixedly held by a holding member in a metallic case disposed in an exhaust pipe of the engine and collects particulate matters included in exhaust gas, wherein
the particulate filter is formed of a monolithic structural body having a multiplicity of cells provided by porous walls in parallel with flow of the exhaust gas,
the particulate filter has a particulate matter collecting area having wall flow structure, in which the cells are blocked alternately with filler on an exhaust gas inlet side or an exhaust gas outlet side of the monolithic structural body, and a cylindrical peripheral heat-retaining layer, which is formed in a peripheral area extending inward from a peripheral surface of the monolithic structural body by a predetermined width and continuously surrounds a periphery of the particulate matter collecting area,
the peripheral heat-retaining layer has structure of ceramic foam in an internal portion thereof, the ceramic foam structure having a higher air content than a peripheral surface portion of the peripheral heat-retaining layer, and
the predetermined width of the peripheral heat-retaining layer ranges from 5 to 20 millimeters.

12. An exhaust gas cleaning system for an internal combustion engine, the exhaust gas cleaning system comprising:
a particulate filter, which is fixedly held by a holding member in a metallic case disposed in an exhaust pipe of the engine and collects particulate matters included in exhaust gas, wherein
the particulate filter is formed of a monolithic structural body having a multiplicity of cells provided by porous walls in parallel with flow of the exhaust gas,
the particulate filter has wall flow structure, in which the cells are blocked alternately with filler on an exhaust gas inlet side or an exhaust gas outlet side of the monolithic structural body, and
the holding member has a predetermined thickness and covers an area of 50 to 100 percent of a peripheral surface of the particulate filter in order to form a peripheral heat-retaining layer around the peripheral surface of the particulate filter.

13. The exhaust gas cleaning system as in claim 12, wherein the holding member expands to fasten the particulate filter in the metallic case when the holding member is heated and becomes 5 to 20 millimeters thick after the holding member is mounted to the exhaust gas cleaning system.

14. An exhaust gas cleaning system for an internal combustion engine, the exhaust gas cleaning system comprising:
a particulate filter, which is fixedly held by a holding member in a metallic case disposed in an exhaust pipe of the engine and collects particulate matters included in exhaust gas, wherein
the particulate filter is formed of a monolithic structural body having a multiplicity of cells provided by porous walls in parallel with flow of the exhaust gas,
the particulate filter has a particulate matter collecting area having wall flow structure, in which the cells are blocked alternately with filler on an exhaust gas inlet side or an exhaust gas outlet side of the monolithic structural body, and a peripheral heat-retaining layer, which is formed by blocking the cells in a peripheral area extending inward from a peripheral surface of the monolithic structural body by a predetermined width and continuously surrounds a periphery of the particulate matter collecting area, and
the monolithic structural body is formed so that a ratio of an area occupied by a layer of air per unit cross-sectional area of the monolithic structural body is higher in the peripheral heat-retaining layer than in the particulate matter collecting area.
